(19) United States
(12) Patent Application Publication
(10) Pub. No.: US 2025/0099326 A1
(43) Pub. Date: Mar. 27, 2025

(54) EXTENSION AND RETRACTION DRIVING MECHANISM AND MASSAGE DEVICE

(71) Applicant: Chengdong You, Chongqing (CN)

(72) Inventor: Chengdong You, Chongqing (CN)

(21) Appl. No.: 18/940,585

(22) Filed: Nov. 7, 2024

(51) Int. Cl. A61H 23/00

(52) U.S. Cl. CPC A61H 23/006; A61H 2201/123; A61H 2201/14; A61H 2201/1664

(57) ABSTRACT

The present disclosure discloses an extension and retraction driving mechanism and a massage device. The extension and retraction driving mechanism includes a drive motor; the drive motor is provided with an output end at one end or two ends; the output ends are fixedly connected with eccentric shafts; shaft levers of the eccentric shafts are fixedly connected with shaft sleeves; the shaft sleeves are provided with drive components; the drive components are fixedly connected with extension and retraction mechanisms; tail ends of the extension and retraction mechanisms are fixedly connected with several massage heads; the drive motor is fixedly connected in a mounting shell; a periphery of the mounting shell is sleeved with an outer rubber cover; and an elastic block on an inner side of the outer rubber cover is connected to the massage heads.

### TECHNICAL FIELD

The present disclosure relates to the technical field of extension and retraction driving, and in particular, to an extension and retraction driving mechanism and a massage device.

### BACKGROUND

In the prior art, massage devices generally achieve beating by driving moving elements to do linear motion through electromagnetic driving. The reciprocating movement of the moving elements is achieved by controlling a direction of current of a coil, and a beating force needs to be achieved by controlling a magnitude of the current. The control difficulty is relatively high, and the beating force may suddenly change, which can cause discomfort to a user during use, resulting in poor user experience and significant vibration during an action.

### SUMMARY

For the shortcomings in the prior art, the present disclosure aims to provide the extension and retraction driving mechanism and the massage device which are good in working stability and excellent in user experience.

To achieve the above objectives, the present disclosure uses a technical solution as follows: An extension and retraction driving mechanism includes a drive motor; the drive motor is provided with an output end at one end or two ends; the output ends are fixedly connected with eccentric shafts; shaft levers of the eccentric shafts are fixedly connected with shaft sleeves; the shaft sleeves are provided with drive components; matching holes matched with the shaft sleeves are provided in the drive components; the drive components are fixedly connected with extension and retraction mechanisms; tail ends of the extension and retraction mechanisms are fixedly connected with several massage heads; the massage heads are made of an elastic material; and shock absorption cavities are provided in the massage heads.

In an embodiment, when the drive motor is provided with only one output end, four massage heads are arranged on the extension and retraction mechanism. When the drive motor is provided with output ends at the two ends, two or four massage heads are respectively arranged on the extension and retraction mechanisms located at the two output ends.

A massage device includes an extension and retraction driving mechanism, a mounting shell and an outer rubber cover. The mounting shell includes an upper shell and a lower shell; the upper shell and the lower shell are fastened with each other; a mounting frame is oppositely mounted in the upper shell and the lower shell; the drive motor is relatively fixedly connected in the mounting frame; through holes are provided in the mounting shell on two sides of the mounting frame; the through holes are respectively opposite to the massage heads at the two ends of the drive motor; the mounting shell is sleeved with the outer rubber cover; an inner side wall of the outer rubber sleeve opposite to the through holes is fixedly connected with elastic blocks; connecting holes are provided in inward sides of the elastic blocks; and the massage heads are connected in the connecting holes in an embedded manner.

In an embodiment, corrugated structures are arranged on an outer side surface of the outer rubber cover opposite to the elastic blocks. A thickness of a wave trough of each corrugated structure is less than a thickness of a wave crest. This can ensure that the elastic blocks have good extension and retraction deformation at these positions. The corrugated structures are preferably annular.

In an embodiment, mounting studs are fixedly connected in the lower shell; threaded holes are provided in upper ends of the mounting studs; mounting holes are respectively provided in the upper shell opposite to the threaded holes; and bolts are in threaded connection into the threaded holes after passing through the mounting holes.

The present disclosure has the following beneficial effects: In this device, the drive motor drives the eccentric shafts to rotate. The eccentric shafts drive the shaft sleeves to do circumferential motion. The shaft sleeves drive the drive components and extension and retraction rods to do relative extension and retraction motion. The extension and retraction motion is a progressive motion, which can avoid vibrations caused by a sudden change motion and can lower the difficulty in control, to reduce the discomfort during massaging and improve the massage comfort level of a user.

### BRIEF DESCRIPTION OF THE DRAWINGS

FIG. 1 is a schematic structural diagram of an extension and retraction driving mechanism according to the present disclosure;

FIG. 2 is a second schematic structural diagram of an extension and retraction driving mechanism according to the present disclosure;

FIG. 3 is a third schematic structural diagram of an extension and retraction driving mechanism according to the present disclosure; and

FIG. 4 is a schematic diagram of a cross-sectional view of a massage device according to the present disclosure.

In the drawings: 1: drive motor; 2: eccentric shaft; 3: shaft sleeve; 4: drive component; 5: matching hole; 6: extension and retraction mechanism; 7: massage head; 8: mounting shell; 9: outer rubber sleeve; 10: mounting frame; 11: elastic block; 12: connecting hole; and 13: mounting stud.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some embodiments of the present disclosure, rather than all the embodiments. All other embodiments obtained by a person of ordinary skill in the art based on the embodiments of the present disclosure without making creative efforts shall fall within the protection scope of the present disclosure.

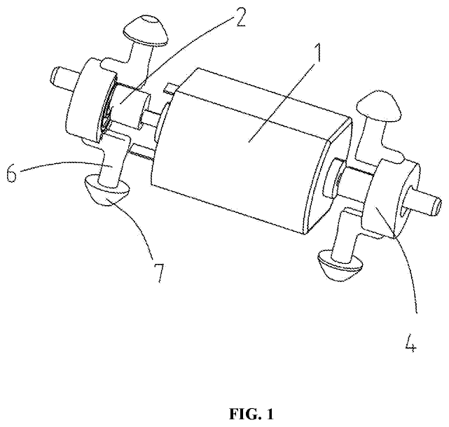

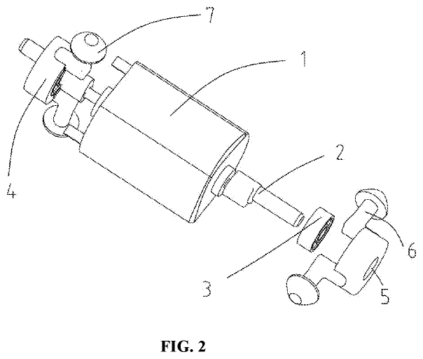

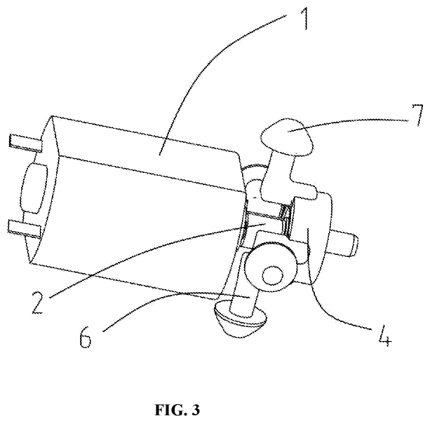

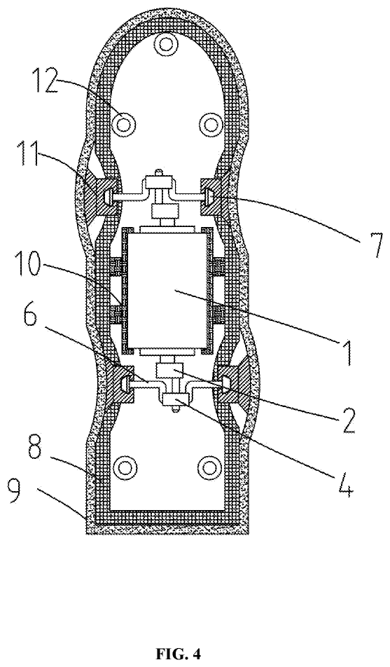

Referring to FIG. 1 to FIG. 4, an extension and retraction driving mechanism includes a drive motor 1; the drive motor 1 is provided with an output end at one end or two ends; the output ends are fixedly connected with eccentric shafts 2; shaft levers of the eccentric shafts 2 are fixedly connected with shaft sleeves 3; the shaft sleeves 3 are provided with drive components 4; matching holes 5 matched with the shaft sleeves are provided in the drive components 4; the drive components 4 are fixedly connected with extension and retraction mechanisms 6; tail ends of the extension and retraction mechanisms 6 are fixedly connected with several massage heads 7; and the massage heads 7 are made of an elastic material. During use, the impact on the motor is further reduced. Meanwhile, when the extension and retraction driving mechanism is applied to massage equipment, the comfort level can be improved too. Shock absorption cavities are provided in the massage heads 7, which can relieve massage force when the extension and retraction driving mechanism is applied to the massage equipment and improve the use experience. During use, the drive motor 1 drives the eccentric shafts 2 to rotate. The eccentric shafts 2 drive the shaft sleeves 3 to do circumferential motion. The shaft sleeves 3 drive the drive components 4 and the extension and retraction mechanisms 6 to do relative extension and retraction motion. The extension and retraction mechanisms 6 drive the massage heads 7 to relatively move, thus driving the elastic blocks 11 to extend and retract in through holes. Thus, the corrugated structures of the outer rubber cover 9 are driven through the elastic blocks 11 to extend and retract in a floating manner. When this part is in contact with the body of a user, a vibration or beating action can be achieved, thus achieving massage.

In an embodiment, when the drive motor 1 is provided with only one output end, four massage heads are arranged on the extension and retraction mechanism 6. The four massage heads move in an extension and retraction manner in four directions through the extension and retraction mechanism 6. Namely, four beating points are arranged on the massage device. When the drive motor 1 is provided with output ends at the two ends, two or four massage heads 7 are respectively arranged on the extension and retraction mechanisms 6 located at the two output ends. Namely, four or eight beating points are arranged on the massage device. If two massage heads are respectively arranged at the two output ends, the two massage heads located at the two output ends are parallel or perpendicular to each other.

A massage device includes an extension and retraction driving mechanism, a mounting shell 8 and an outer rubber cover 9. The mounting shell 8 includes an upper shell and a lower shell; the upper shell and the lower shell are fastened with each other; a mounting frame 10 is oppositely mounted in the upper shell and the lower shell; the drive motor 1 is relatively fixedly connected in the mounting frame 10; through holes are provided in the mounting shell 8 on two sides of the mounting frame 10; the through holes are respectively opposite to the massage heads 7 at the two ends of the drive motor 1; the mounting shell 8 is sleeved with the outer rubber cover 9; an inner side wall of the outer rubber sleeve 9 opposite to the through holes is fixedly connected with elastic blocks 11; the elastic blocks 11 are made of silica gel or other elastic materials; connecting holes 12 are provided in inward sides of the elastic blocks 11; and the massage heads 7 are connected in the connecting holes 12 in an embedded manner.

In an embodiment, corrugated structures are arranged on an outer side surface of the outer rubber cover 9 opposite to the elastic blocks 11. A thickness of a wave trough of each corrugated structure is less than a thickness of a wave crest. This can ensure that the elastic blocks 11 have good extension and retraction deformation at these positions. The corrugated structures are preferably annular.

In an embodiment, mounting studs 13 are fixedly connected in the lower shell; threaded holes are provided in upper ends of the mounting studs 13; mounting holes are respectively provided in the upper shell opposite to the threaded holes; and bolts are in threaded connection into the threaded holes after passing through the mounting holes to relatively fix the upper shell and the lower shell during use.

For those skilled in the art, it is apparent that the present disclosure is not limited to the details of the exemplary embodiments mentioned above, and can be implemented in other specific forms without departing from the spirit or basic features of the present disclosure. Therefore, in any perspective, the embodiments should be regarded as exemplary and non-restrictive. The scope of the present disclosure is limited by the accompanying claims rather than the above description. Therefore, all changes within the meaning and scope of the equivalent conditions of the claims within the present disclosure. Any reference numerals in the claims should not be regarded as limiting the claims involved.

In addition, it should be understood that although this specification is described according to the implementations, not each implementation only includes one independent technical solution. This narration method of this specification is only for clarity. A person skilled in the art should regard this specification as a whole, and the technical solutions in the respective embodiments can also be appropriately combined to form other implementations that can be understood by a person skilled in the art.

What is claimed is:

1. An extension and retraction driving mechanism, comprising a drive motor (1), wherein the drive motor (1) is provided with an output end at one end or two ends; the output ends are fixedly connected with eccentric shafts (2); shaft levers of the eccentric shafts (2) are fixedly connected with shaft sleeves (3); the shaft sleeves (3) are provided with drive components (4); the drive components (4) are fixedly connected with extension and retraction mechanisms (6); tail ends of the extension and retraction mechanisms (6) are fixedly connected with several massage heads (7); and
two or four massage heads (7) are respectively arranged on the extension and retraction mechanisms (6) located at the two output ends.

2. The extension and retraction driving mechanism according to claim 1, wherein matching holes (5) matched with the shaft sleeves are provided in the drive components (4).

3. The extension and retraction driving mechanism according to claim 1, wherein the massage heads (7) are made of an elastic material; and shock absorption cavities are provided in the massage heads (7).

4. A massage device, comprising the extension and retraction driving mechanism according to claim 1, and further comprising a mounting shell (8) and an outer rubber cover (9), wherein the mounting shell (8) comprises an upper shell and a lower shell; the upper shell and the lower shell are fastened with each other; a mounting frame (10) is oppositely mounted in the upper shell and the lower shell; the drive motor (1) is relatively fixedly connected in the mounting frame (10); through holes are provided in the mounting shell (8) on two sides of the mounting frame (10); the through holes are respectively opposite to the massage heads (7) at the two ends of the drive motor (1); the mounting shell (8) is sleeved with the outer rubber cover (9); an inner side wall of the outer rubber sleeve (9) opposite to the through holes is fixedly connected with elastic blocks (11); connecting holes (12) are provided in inward sides of the elastic blocks (11); and the massage heads (7) are connected in the connecting holes (12) in an embedded manner.

5. The massage device according to claim 4, wherein corrugated structures are arranged on an outer side surface of the outer rubber cover (9) opposite to the elastic blocks (11).

6. The massage device according to claim 4, wherein mounting studs (13) are fixedly connected in the lower shell; threaded holes are provided in upper ends of the mounting studs (13); mounting holes are respectively provided in the upper shell opposite to the threaded holes; and bolts are in threaded connection into the threaded holes after passing through the mounting holes.
